(19) United States
(12) Patent Application Publication
(10) Pub. No.: US 2025/0135937 A1
(43) Pub. Date: May 1, 2025

(54) VEHICLE AND SYSTEM

(71) Applicant: TOYOTA JIDOSHA KABUSHIKI KAISHA, Toyota-shi (JP)

(72) Inventor: Keisuke KANAMARU, Nagoya-shi (JP)

(73) Assignee: TOYOTA JIDOSHA KABUSHIKI KAISHA, Toyota-shi (JP)

(21) Appl. No.: 18/884,374

(22) Filed: Sep. 13, 2024

(30) Foreign Application Priority Data
Oct. 10, 2023 (JP) 2023-175318

(51) Int. Cl. B60L 53/66

(52) U.S. Cl. CPC B60L 53/66

(57) ABSTRACT

The vehicle is configured to provide electrical equipment and power transfer. The vehicle is configured to perform power transfer in either the first control mode or the second control mode. The first control mode is a control mode in which power transfer is performed based on an instruction determined by the vehicle. The second control mode is a control mode in which power transfer is performed based on an instruction determined by the electrical equipment. The vehicle is configured to obtain user mode information indicating whether a user of the vehicle desires a first control mode or a second control mode. The vehicle uses the user mode information to determine which of the first control mode and the second control mode is to be notified to the electrical equipment.

### CROSS-REFERENCE TO RELATED APPLICATION

This application claims priority to Japanese Patent Application No. 2023-175318 filed on Oct. 10, 2023, incorporated herein by reference in its entirety.

### BACKGROUND

### 1. Technical Field

The present disclosure relates to vehicles and systems that perform power transfer.

### 2. Description of Related Art

Japanese Unexamined Patent Application Publication No. 2021-158838 (JP 2021-158838 A) discloses a technique of performing energy management by power transfer between vehicles and electrical equipment.

### SUMMARY

In order to perform high-response energy management according to the supply-demand situation, it is desirable that power transfer be performed based on instructions determined by electrical equipment. However, in a system in which electrical equipment takes the initiative in performing power transfer, sufficient power may not always be supplied to a vehicle in a situation where the vehicle user wants to complete charging quickly. On the other hand, in a system in which a vehicle takes the initiative in performing power transfer, there is a possibility that energy management may not be properly performed. There remains room for improvement in the way in which power transfer between vehicles and electrical equipment is controlled.

The present disclosure was made to address the above issue, and an object of the present disclosure is to provide a vehicle and system that facilitate power transfer desired by a vehicle user.

A vehicle according to an aspect of the present disclosure is configured to perform power transfer to and from electrical equipment. The vehicle is configured to perform the power transfer in either a first control mode or a second control mode. The first control mode is a control mode in which the power transfer is performed based on an instruction determined by the vehicle. The second control mode is a control mode in which the power transfer is performed based on an instruction determined by the electrical equipment. The vehicle is configured to acquire user mode information indicating whether a user of the vehicle desires the first control mode or the second control mode. The vehicle uses the user mode information to determine which of the first control mode and the second control mode is to be notified to the electrical equipment.

The present disclosure facilitates power transfer desired by vehicle users.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a power transfer system according to an embodiment of the present disclosure;

FIG. 2 is a flowchart showing a process performed by user equipment shown in FIG. 1;

FIG. 3 is a flowchart illustrating charge control according to an embodiment of the present disclosure;

FIG. 4 is a flowchart showing details of the scheduled charge control shown in FIG. 3;

FIG. 5 is a flow chart detailing the dynamically charged control shown in FIG. 3; and

FIG. 6 is a diagram illustrating a modification of the configuration illustrated in FIG. 1.

### DETAILED DESCRIPTION OF EMBODIMENTS

An embodiment of the present disclosure will be described in detail with reference to the drawings. The same or corresponding parts in the drawings are designated by the same reference signs and repetitive description will be omitted.

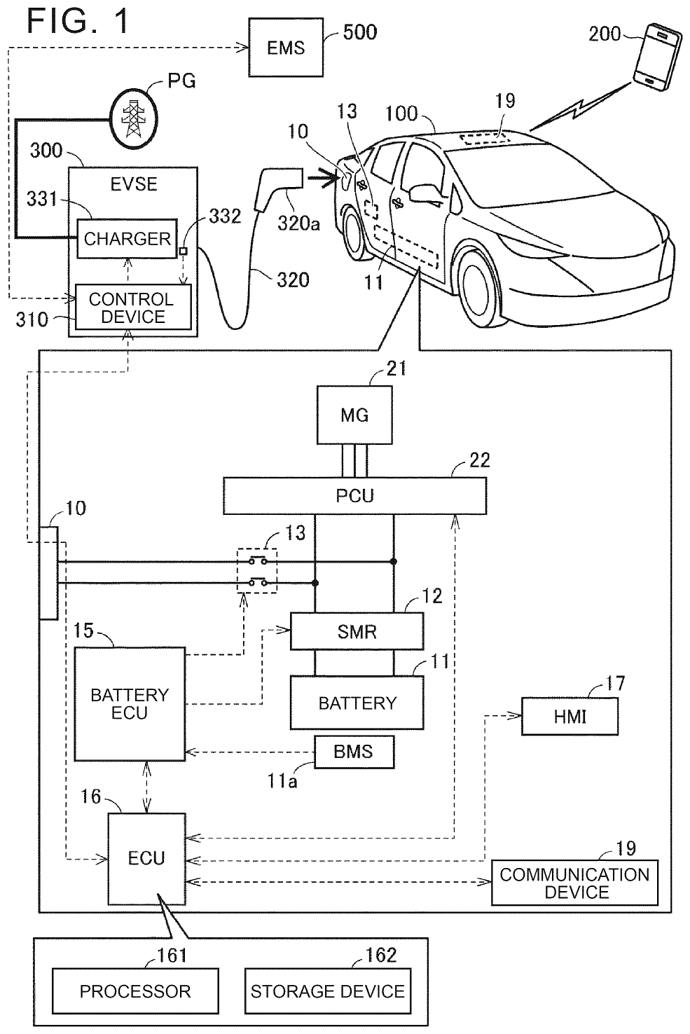

FIG. 1 is a diagram illustrating a power transfer system according to an embodiment of the present disclosure. The power transfer system shown in FIG. 1 includes a vehicle 100, an EVSE 300, and EMS 500. “EVSE” means Electric Vehicle Supply Equipment. “EMS” means Energy Management System. EVSE 300 is supplied with power from a power system PG. The power system PG is a power grid constructed by a transfer and distribution facility. A plurality of power plants (not shown) is connected to the power system PG. The power system PG supplies AC power via, for example, a transformer (not shown).

EVSE 300 includes a control device 310, a charger 331, and a detector 332, and includes a charging cable 320. The charging cable 320 has a connector 320a (charge connector) at its distal end, and includes a communication line and a power line therein. One electric wire may also serve both as a communication line and a power line. The control device 310 functions as a SECC that communicates with one or more EVCC, which will be described later. “EVCC” means a communication controller for an electrified vehicle (Electric Vehicle Communication Controller). “SECC” means a communication controller for supply equipment (Supply Equipment Communication Controller). The control device 310 may control input/output channels, data encryption, or data transfer between the vehicle 100 and EVSE 300. In addition, the control device 310 is configured to be able to interact with SA (Secondary Actor). In this embodiment, EMS 500 corresponds to SA. The control device 310 is configured to communicate with an EMS 500. EMS 500 may include a computer that manages power supply and demand balances in a building such as a house or a factory, or a computer that functions as an aggregator that bundles a plurality of resources. EMS 500 requests power transfer for energy management to the control device 310 as needed.

The control device 310 controls the charger 331. The charger 331 includes a power conversion circuit (for example, an inverter). The detector 332 includes various sensors for detecting the state (voltage, current, temperature, and the like) of the charger 331, and outputs a detection result to the control device 310. The charger 331 converts AC power supplied from the power system PG into DC power in response to a command from the control device 310, and outputs the DC power to the connector 320a. EVSE 300 outputs DC power.

Vehicle 100 includes inlet 10 to which a connector 320a can be attached and detached. The vehicle 100 is electrically connected to the power system PG via EVSE 300 by connecting the connector 320a of the charging cable 320 connected to the main body of EVSE 300 to the inlet 10 of the vehicle 100 in the parked state (plugged-in state). On the other hand, when the inlet 10 is not connected, the vehicle 100 is not electrically connected to each of EVSE 300 and the power system PG (plugged-out state).

The vehicle 100 further includes a battery 11, a SMR (System Main Relay) 12, a charging relay 13, ECUs 15, 16, an HMI (Human Machine Interface) 17, a communication device 19, a MG (Motor Generator) 21, and a PCU (Power Control Unit) 22. “ECU” means an electronic control unit. Electric power is supplied from an auxiliary battery (not shown) to the respective ECU (ECUs 15, 16) mounted on the vehicle 100. When the amount of electric power stored in the auxiliary battery decreases, electric power is supplied from the battery 11 to the auxiliary battery.

ECUs 15 and 16 are configured to be able to communicate with each other. ECU 15 functions as a computer (battery ECU) that manages the battery 11. ECU 16 functions as an EVCC that communicates with SECC. ECU 16 may control input/output channels, data encryption, or data transfer between vehicle 100 and EVSE 300.

The battery 11 includes, for example, a secondary battery such as a lithium ion secondary battery. The vehicle 100 is configured to be able to travel using electric power stored in the battery 11. The vehicle 100 is, for example, battery electric vehicle (BEV) without engines (internal combustion engines). However, the present disclosure is not limited thereto, and the vehicle 100 may be PHEV (plug-in hybrid electric vehicle) including an internal combustion engine, or may be other electrified vehicles (xEV).

The battery 11 is provided with a BMS (Battery Management System) 11a for monitoring the status of the battery 11. BMS 11a includes various sensors for detecting the status of the battery 11, and a monitoring IC (integrated circuit) for receiving a detection signal from the various sensors. The monitoring IC generates a signal (hereinafter, referred to as a “BMS signal”) indicating the status of the battery 11 by using the detection signals from the various sensors, and outputs the generated BMS signal to ECU 15. ECU 15 acquires, for example, the temperature, current, voltage, and SOC (State of Charge) of the battery 11 based on BMS signal. SOC indicates the amount of stored electricity, and represents, for example, the ratio of the present amount of stored electricity to the amount of stored electricity in a fully charged state in the range of 0 to 100%.

The vehicle 100 is configured to be capable of performing external charging (charging of the battery 11 by electric power from the outside of the vehicle). The charging relay 13 switches connection/disconnection of the charging line. During the external charging, SMR 12 and the charging relay 13 are in the closed state (connected state), and the DC power outputted from EVSE 300 to the vehicle 100 is inputted to the inlet 10, and the battery 11 is charged. ECU 15 controls SMR 12 and charging relay 13 in accordance with instructions from ECU 16. In the embodiment shown in FIG. 1, a charging line including an inlet 10 and a charging relay 13 is connected between SMR 12 and PCU 22. However, the present disclosure is not limited thereto, and a charge line may be connected between the battery 11 and SMR 12.

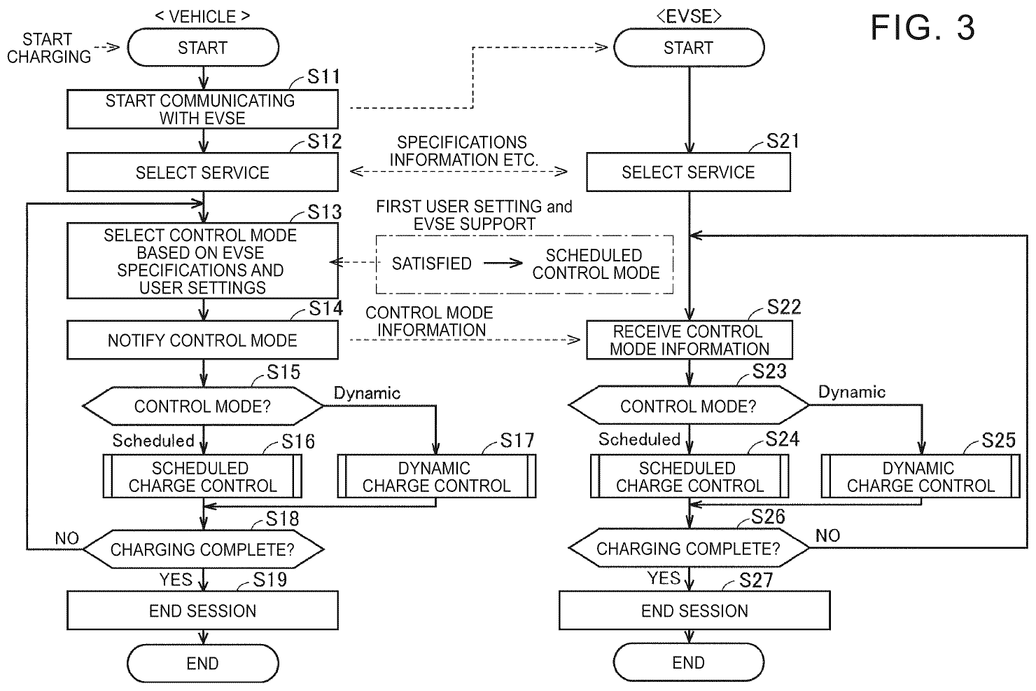

ECU 16 includes a processor 161 and a storage device 162. The storage device 162 is configured to store stored information. The storage device 162 stores various kinds of information used in the program in addition to the program. The storage device 162 stores, for example, information used in control of power transfer (including a scheduled departure time and user mode information to be described later). In this embodiment, the processor 161 executes a program stored in the storage device 162 to execute various kinds of control (for example, control illustrated in FIGS. 3 to 5 described later). However, these processes may be executed only by hardware (electronic circuit) without using software.

PCU 22 includes inverters and converters, for example, and drives MG 21 using power supplied from the battery 11. MG 21 is driven by PCU 22 to rotate the drive wheels of the vehicle 100. Further, MG 21 performs regenerative power generation and outputs the generated electric power to the battery 11. SMR 12 switches the connection/disconnection of the electric path from the battery 11 to PCU 22. SMR 12 is maintained in a closed state (connected state) while the vehicle 100 is traveling.

HMI 17 includes an inputting device and a displaying device. HMI 17 may include a touch panel display. HMI 17 may include an operating portion (e.g., a button) provided on the steering wheel. HMI 17 may include a meter panel and/or a head-up display. HMI 17 may include a smart speaker that accepts audio input.

The communication device 19 may include a TCU (Telematics Control Unit) and/or a DCM (Data Communication Module) for performing radio communication. ECU 16 performs radio communication with the mobile terminal 200 through the communication device 19. The mobile terminal 200 is configured to be portable by a user. In this embodiment, a smartphone including a touch panel display is adopted as the mobile terminal 200. The smartphone has a built-in computer and has a speaker function. However, the present disclosure is not limited thereto, and a laptop, a portable game machine, a wearable device, an electronic key, and the like can also be employed as the mobile terminal 200.

The vehicle 100 and EVSE 300 perform power transfer (for example, charge the battery 11 in a plugged-in state). In the power transfer methods according to this embodiment, the vehicle 100 corresponding to EV (Electric Vehicle) performs power transfer between the vehicle 100 and EVSE 300 while communicating with EVSE 300. Vehicle 100 is configured to perform power transfer in either a scheduled or a dynamic control mode. The scheduled control mode corresponds to a first control mode in which power transfer is performed based on an instruction determined by the vehicle. The dynamic control mode corresponds to a second control mode in which power transfer is performed based on an instruction determined by the electrical equipment (EVSE). These control modes may have the features defined in ISO 15118-20. In the dynamic control mode, the vehicle 100 is enabled to perform power transfer for VPP (virtual power plant).

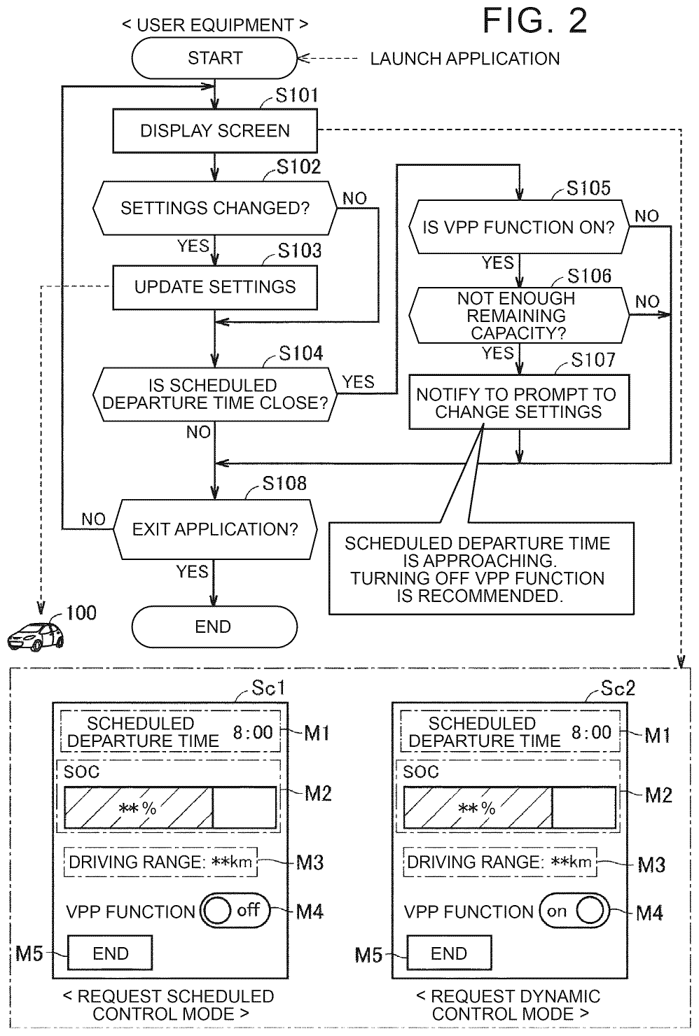

An application software (hereinafter, simply referred to as “application”) related to the power transfer is installed in the mobile terminal 200. The mobile terminal 200 is operated by a user (vehicle user) of the vehicle 100. The mobile terminal 200 receives an input (hereinafter, referred to as “request mode input”) indicating which of the scheduled control mode and the dynamic control mode the vehicle user desires through the application. FIG. 2 is a flowchart showing a process executed by the mobile terminal 200 during the application operation. Each step in the flowchart is simply referred to as “S”. For example, when the application is activated by a user operation on the mobile terminal 200, the mobile terminal 200 starts the processing flow illustrated in FIG. 2. In this embodiment, the mobile terminal 200 functions as user equipment. However, instead of the mobile terminal 200, HMI 17 may execute the process illustrated in FIG. 2 as user equipment.

Referring to FIG. 2, in S101, the mobile terminal 200 displays a display Sc1 or a Sc2. Specifically, the mobile terminal 200 holds user mode information indicating whether the vehicle user desires a scheduled control mode or a dynamic control mode. Hereinafter, a state in which the user mode information indicates that the vehicle user desires the scheduled control mode is referred to as “first user setting”. Further, a state in which the user mode information indicates that the vehicle user desires the dynamic control mode is referred to as “second user setting”.

The mobile terminal 200 set by the first user displays the display Sc1 in S101. The display Sc1 includes display units M1 to M3 and operating units M4, M5. The display unit M1 indicates the scheduled departure time set in the application. The set value of the scheduled departure time can be changed. For example, when the user touches the display unit M1, a keypad for inputting a numerical value may be displayed. The display unit M2 indicates SOC of the battery 11. The display unit M3 indicates a travelable range of the vehicle 100. The mobile terminal 200 sequentially receives SOC of the battery 11 detected by BMS 11a from the vehicle 100. The mobile terminal 200 calculates the travelable range of the vehicle 100 based on SOC of the battery 11. The operating unit M4 receives a request mode input. The operating unit M4 is, for example, a toggle switch, and is switched on/off in response to an operation from the user. The vehicle user can switch from the first user setting to the second user setting by ON operating the operating unit M4. The operating unit M5 receives an input (for example, a button operation) for ending the application.

The mobile terminal 200 set by the second user displays the display Sc2 in S101. The screen Sc2 includes display units M1 to M3 and operating units M4, M5, similar to the screen Sc1. However, in the display Sc2, the operating unit M4 is turned on. The vehicle user can switch from the second user setting to the first user setting by OFF operating the operating unit M4.

In the following S102, the mobile terminal 200 determines whether or not the user has inputted a setting change. Specifically, when the scheduled departure time is changed or the operating unit M4 is switched on/off in the display Sc1 or Sc2, it is determined as YES in S102, and the process proceeds to S103. In S103, the mobile terminal 200 changes the information (for example, the scheduled departure time or the user mode information) held by its own storage device in response to an entry from the user. As a result, the setting of the mobile terminal 200 is updated. Further, the mobile terminal 200 requests the vehicle 100 to change the setting in the same manner. Specifically, the mobile terminal 200 transmits user mode information corresponding to an input from the user to the vehicle. As a result, the information (the scheduled departure time and the user mode information) held by the storage device 162 is changed in response to the user input to the mobile terminal 200. The second user setting of the vehicle 100 (ECU 16) means that VPP function of the vehicle 100 is turned on. Thereafter, the process proceeds to S104. On the other hand, when the mobile terminal 200 has not received an entry for setting change (NO in S102), S103 process (setting update) is not performed, and the process proceeds to S104.

In S104, the mobile terminal 200 determines whether or not the scheduled departure time is close. Specifically, the mobile terminal 200 determines whether or not a predetermined time (for example, 30 minutes) has elapsed from the set scheduled departure time. When the scheduled departure time is close (YES in S104), the mobile terminal 200 determines in S105 whether or not the present setting is the second user setting. When the present setting is the second user setting (YES in S105), the mobile terminal 200 determines in S106 whether or not the power storage capacity of the battery 11 is insufficient for the subsequent traveling. The mobile terminal 200 may determine whether SOC of the battery 11 is equal to or less than a predetermined value. Alternatively, the mobile terminal 200 may determine whether or not the travelable distance of the vehicle 100 is equal to or less than a predetermined value. When the storage capacity of the battery 11 is insufficient (YES in S106), the mobile terminal 200 performs notification by, for example, displaying or sounding (including sound) in S107. The mobile terminal 200 prompts the vehicle user to switch from the second user setting to the first user setting by the notification processing.

When S107 process is executed, the process proceeds to S108. On the other hand, when NO is determined in any of S104, S105, S106, the process proceeds to S108 without performing S107 process (notification process). In S108, the mobile terminal 200 determines whether to terminate the application. For example, when the operating unit M5 is operated by the user in the screen Sc1 or Sc2, it is determined that the operating unit is YES in S108, and the process is terminated. When the application is not terminated (NO in S108), the process returns to S101, and the display of the screen is continued.

In this embodiment, the scheduled departure time is set by the user, but the mobile terminal 200 may receive the scheduled departure time from the vehicle 100. The vehicle 100 (ECU 16) may predict the departure time of the vehicle 100 based on historical data (travel history data), and transmit the predicted departure time (scheduled departure time) to the mobile terminal 200. The processing flow illustrated in FIG. 2 can be changed as appropriate. For example, S104 to S107 may be omitted.

Referring back to FIG. 1, EVCC of EV (e.g., ECU 16) and SECC of EVSE (e.g., control device 310) select the servicing prior to power transfer. Specifically, EVCC launches a communication session and requests a service available to SECC. SECC answers the appropriate listing of services that can be provided to EVCC. EVCC then selects the service to use and sends the service ID to SECC. SECC returns detailed information (parameter list) of the selected service. This is done in a loop. That is, SECC sequentially transmits the service details for each service for which EVCC requests information. EVCC then selects, for example, an energy transfer service. This allows EVCC and SECC to exchange messages regarding physical limitations under the rated operating conditions of the selected energy transfer service. EVCC and SECC select and negotiate servicing operations through this messaging. Once the servicing operation is determined by EVCC and SECC agreement, the message set to be applied is uniquely determined. In one embodiment, the following are exchanged between EVCC and SECC: Signals defined in ISO 15118-20 may be used.

EVCC requests SECC by using the following message.

The session setting request is a signal requesting the start of a communication session. EVCC setting request includes an EVCCID for specifying the sessions. The session stopping request is a signal requesting termination or Pause of the power transfer process. The session stop request includes a charging session. The charging session may be set to “end” and “pause”. A session stop request in which “end” and “pause” are set in the charging session requests end and pause of the power transfer process, respectively.

The service discovery request is a signal requesting that all services provided by SECC be transmitted. The service discovery request includes a list of identities (service ID) that identify services supported by EV. EVCC can restrict servicing by sending such listings. The service discovery request distinguishes between different types and coverage of services. The service detail request is a signal requesting EVSE to transmit a particular additional information regarding the service provided. The service detailed request includes identification information (service ID) of a service for which additional information is requested. The service selection request is a signal for notifying information about the selected service. The service selection request includes a selected VAS (value-added service) list. This listing contains all selected servicing ID and parameter set ID.

The scheduled switching request is a signal that provides a power transfer parameter to SECC and requests SECC to provide information about the power transfer. The scheduled exchange request provides, for example, status information about EV and additional power transfer parameters (e.g., the amount of charge power required to resolve the shortage of storage capacity and the scheduled departure time obtained in the process flow illustrated in FIG. 2).

The power supply request (power delivery request) is a signal that requires SECC to provide power. The power feed requirements include control mode information, an EV power profile, and charge progress. EV uses EV power profile to announce and reserve a power transfer profile for the present charge session. “Start”, “Stop”, “Re-Schedule Negotiation”, and “Standby” may be set for charge progress. EVCC can request the standby (hereinafter, also referred to as “first standby”) and the pause (hereinafter, also referred to as “second standby”) from SECC using the power supply request.

A power supply request that is set to “start” in charge progress requires EVSE to prepare an energy flow for immediate start. A power supply request with “scheduled renegotiation” set in the charging progress requires a scheduled renegotiation mechanism. The power supply request in which “standby” is set in the charge progress requests EVSE that EV enters the first standby period. During the first standby period, the power transfer between EV and EVSE is stopped (zero power). However, in the first waiting interval, communication between EV and EVSE is maintained.

A power supply request that is set to “Stop” is requested to EVSE to stop the energy flow. If EVCC desires a second Pause, EVCC sends a power supply request with a “pause” set to the charge progress to SECC and then sends a session stop request with a “pause” set to the charge session to SECC. In the second standby time, the power transfer between EV and EVSE is stopped and the communication between the two is stopped.

The charge loop request is a signal that periodically notifies EVSE of information about charge. For example, in the dynamic control mode, EVCC periodically notifies SECC of the present value and the limit value of the charging parameter (charging voltage, charging current, charging power, etc.) using the charge loop request. In the scheduled control mode, EVCC periodically notifies SECC of the current value of the charging parameter, the target value of the charging parameter requested by EV, and the difference between the target value and the current value by using the charge loop request.

In response to a request from EVCC, SECC transmits the following response-signal (message):

The session setting response is a response signal to the session setting request. The session setup response includes an EVSEID and a response code. EVSEID is the identity of EVSE connected to EV. The response code indicates whether the new session was launched or successfully joined to the previous communication session. The session stop response is a response signal to the session stop request. The session deactivation response informs EVCC whether the pause of the power transfer process has been accepted or whether the power transfer process has been terminated successfully.

The service discovery response is a response signal to the service discovery request. The service discovery reply includes a listing of all services available in SECC. The service detail response is a response signal to the service detail request. The service detail reply provides details about the service (including the specifications of EVSE). The service selection response is a response signal to the service selection request. The service selection reply informs EVCC whether the selected service has been accepted.

The schedule exchange response is a response signal to the schedule exchange request. The schedule exchange response provides, for example, cost information regarding at least one of money, time, demand, and consumption in the power transfer. SECC may provide power transfer parameters applicable from a power grid (grid) point of view using scheduled switching responses.

The power supply response (power delivery response) is a response signal to a power supply request. The power supply response includes information indicating whether the power requested by the power supply request is available or whether EVSE accepts the wait requested by the power supply request. In addition, the power supply response includes an EVSE status indicating the status of EVSE or notifying the user of an event related to EVCC.

The charge loop response is a response signal to a charge loop request. The charge loop response informs EV of the status of EVSE and the current and voltage outputted by the present EVSE. The charge loop response includes parameters indicative of the current and voltage of the current EVSE, parameters indicative of whether an upper limit has been reached for each of the current, voltage, and power of the current EVSE, and parameters indicative of the energy charged during the current service session.

The communication session always begins with the session setup message pair described above and ends with a session stop message pair. EVCC may enter a first waiting period during the communication session and resume communication after the first waiting period has elapsed. All messages in a communication session have a session ID that allows the session to be managed at the application level. The session ID is negotiated between EVCC and SECC by a session configuration message pair. All messages except the Session Setup Request message use the same session ID.

FIG. 3 is a flowchart illustrating charge control according to the embodiment. The process illustrated in FIG. 3 is executed by ECU 16 when a predetermined charge start condition is satisfied in the plugged-in state vehicle 100. The charge starting condition is satisfied, for example, when the vehicle 100 is connected to EVSE 300 and the plugged-in state described above is established.

Referring to FIG. 3, in S11, ECU 16 (EVCC) initiates communication with the control device 310 (SECC). As a result, a communication session is established. Subsequently, in S12 and S21, ECU 16 and control device 310 selects a service through the aforementioned service selection process. At this time, the control device 310 transmits EVSE 300 specification information (information on the physical capability of the system, the operation mode, and the like) to ECU 16 using the service detailed response. This specification information corresponds to equipment mode information indicating whether or not the electrical equipment (EVSE) supports the first control mode (scheduled control mode). Hereinafter, the fact that EVSE 300 connected to the vehicle 100 supports the scheduled control mode will be referred to as “EVSE support”, and the fact that it does not correspond to “EVSE non-support”.

In the following S13, ECU 16 selects either the scheduled control mode or the dynamic control mode using the user mode information and EVSE 300 spec information. Subsequently, ECU 16 notifies EVSE 300 of the selected control mode using the power supply requirement in S14. In this embodiment, when the first user setting and EVSE support are satisfied, ECU 16 notifies EVSE 300 of the scheduled control mode in S14. On the other hand, when the second user setting or EVSE non-support, ECU 16 notifies EVSE 300 of the dynamic control mode by S14. However, when EVSE 300 does not support the dynamic control mode but supports the scheduled control mode, ECU 16 notifies EVSE 300 of the scheduled control mode even in the second user setting.

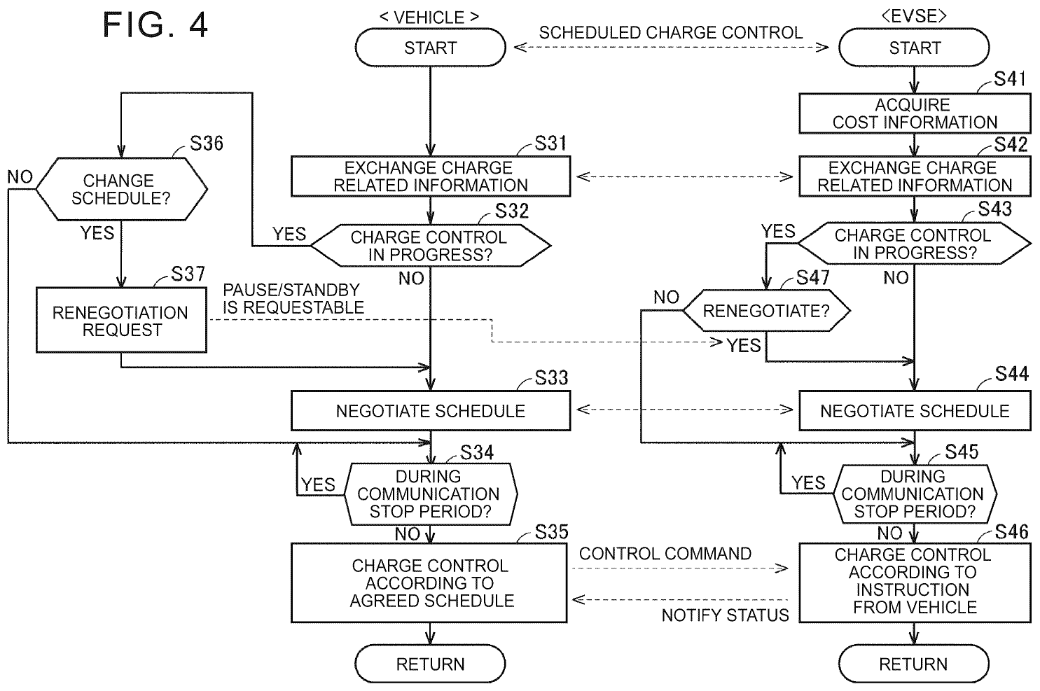

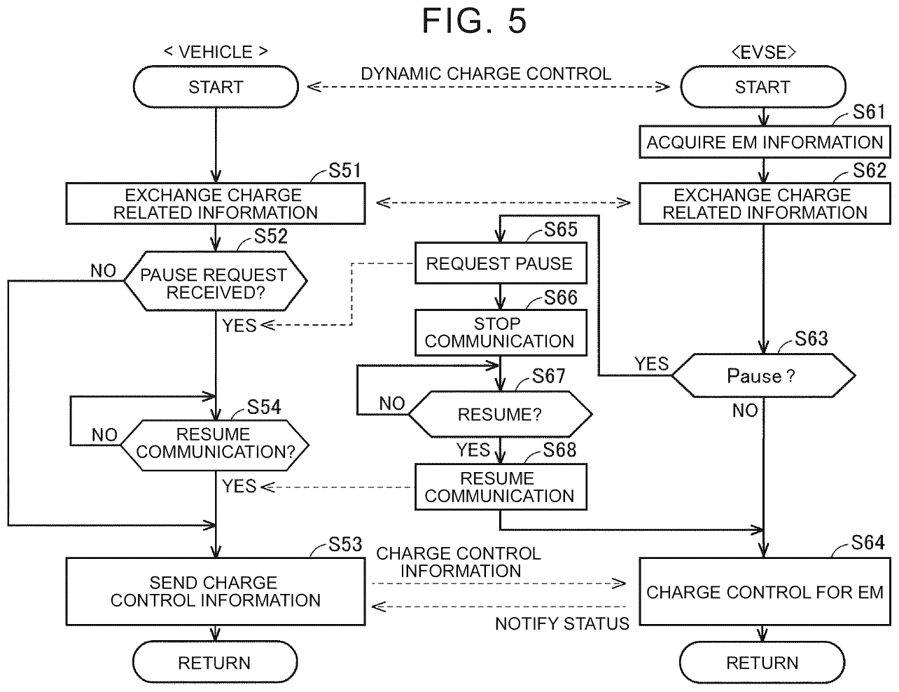

The control device 310 receives a notification (control mode information) from the vehicle 100 in S22. In a subsequent S15, S23, the control device 310 ECU 16 determines which of the scheduled control mode and the dynamic control mode is selected, respectively. When the scheduled control mode is selected, the process proceeds to S16, S24. In S16 and S24, scheduled charge control shown in FIG. 4 described later is executed. When the dynamic control mode is selected, the process proceeds to S17, S25. In S17 and S25, the dynamical charge control shown in FIG. 5 described later is executed. In this way, when the control mode is notified by S14, the vehicle 100 and EVSE 300 perform power transfer in the notified control mode.

When the scheduled charge control or the dynamic charge control is executed, the control device 310 ECU 16 determines whether or not the charge of the battery 11 is completed in each subsequent S18, S26. When the charge is not completed (NO in S18, S26), the process returns to S13, S22. On the other hand, when the charge is completed (YES in S18, S26), ECU 16 and the control device 310 terminate the communication session in S19, S27. As a result, the processing flow illustrated in FIG. 3 ends.

In this embodiment, the vehicle user can activate an application of the mobile terminal 200 (user equipment) at an arbitrary timing (see FIG. 2). Therefore, the vehicle user can switch between the first user setting and the second user setting even while the power transfer is being performed. When the vehicle 100 acquires the user mode information changed from the first user setting to the second user setting from the mobile terminal 200 during the power transfer in the scheduled control mode, the ECU 16 notifies the EVSE 300 of the dynamic control mode in S14. As a result, switching from the scheduled charge control to the dynamic charge control is performed. However, when EVSE 300 does not support the dynamic control mode, the scheduled control mode is notified in S14, and the scheduled charge control is continued.

FIG. 4 is a flow chart detailing scheduled charge control (S16, S24). Referring to FIG. 4, in S41, the control device 310 acquires cost information regarding power transfer. The cost information indicates, for example, an electricity rate for each time zone. Subsequently, ECU 16 and control device 310 uses the scheduled exchange message pair to exchange charge related information at S31 and S42. The charge related information sent from EVSE 300 to the vehicle 100 includes the above cost information. In the following S32, S43, ECU 16 and the control device 310 determine whether or not charge control is being performed. Prior to starting the charge control, it is determined that S32, S43 is NO, and the process proceeds to S33, S44. In S33 and S44, ECU 16 and control device 310 negotiates for a power transfer profile and the power transfer profile is modified as needed. The power transfer profile may indicate a charging plan (charging schedule), and more specifically, may indicate a transition of the charging power value in a predetermined period. For example, ECU 16 may generate a power transfer profile that matches the mobility needs of the vehicle user. ECU 16 may set a power transfer profile in which the shortage of the electric storage amount is eliminated the earliest while the electric storage amount of the battery 11 is insufficient. In addition, ECU 16 may set the first standby period or the second standby period in a period in which the amount of electricity stored in the battery 11 is not insufficient based on the above cost information. ECU 16 may evaluate the storage capacity of the battery 11 by the same method as S106 of FIG. 2. ECU 16 presents the generated power transfer profile to the control device 310. The control device 310 agrees on the power transfer profile presented by the vehicle 100 when it can be handled by the EVSE 300.

In the following S34, S45, the control device 310 determines whether or not the communication is stopped, which is indicated by the agreed power transfer profile, for ECU 16. For example, the above second standby period corresponds to a communication stop period. The second waiting period may be set to the power transfer profile in response to a request from the vehicle 100. If the communication is stopped (YES in S34, S45), the power transfer between the vehicle 100 and EVSE 300 is temporarily stopped, and the communication between the two is also stopped. After that, when the communication stoppage period has elapsed (NO in S34, S45), the communication is resumed, and the process proceeds to S35, S46.

In S35, ECU 16 determines an indication regarding charge control so that charging of the battery 11 according to the agreed power transfer profile is performed, and transmits the determined indication to EVSE 300. For example, ECU 16 may transmit a target charge parameter to EVSE 300 using a charge loop requirement. In addition, ECU 16 may transmit, to EVSE 300, a power supply request in which “standby” is set in the charge progress so that the power transfer is stopped in the first standby period indicated by the power transfer profile. In S46, the control device 310 controls the charger 331 so that power transfer based on an instruction from ECU 16 is performed. In addition, the control device 310 notifies ECU 16 of the present EVSE status and the like by using the charge loop response. Thereafter, the process shown in FIG. 4 ends, and the process proceeds to S18, S26 of FIG. 3. However, while the power transfer is continued without changing the control mode, the process of S16, S24 of FIG. 3 (the process flow shown in FIG. 4) is repeatedly executed. As described above, in the scheduled control mode, power transfer is performed under the initiative of EVCC (ECU 16).

When the charge control of the battery 11 is started by S35, S46 process, it is determined that S32, S43 is YES, and the process proceeds to S36, S47. In S36, ECU 16 determines whether to change the agreed upon power transfer profile. If ECU 16 wants to change the power transfer profile (YES at S36), ECU 16 requests renegotiation from the control device 310 at S37. In S47, the control device 310 determines whether a renegotiation is requested. When EVSE 300 is requested for renegotiation from the vehicle 100 (YES at S47), the process proceeds to S33, S44 and ECU 16 and control device 310 negotiates for the power transfer profile changed by ECU 16. On the other hand, if ECU 16 does not wish to change the power transfer profile (NO in S36, S47), the process proceeds to S34, S45, and if not within the communication stoppage, then in a subsequent S35, S46, the battery 11 is charged according to the agreed power transfer profile.

FIG. 5 is a flow chart detailing a dynamically charged S17, S25. Referring to FIG. 5, in S61, the control device 310 acquires EM related to energy management (hereinafter, referred to as “EM”) required by EMS 500. EM data indicates, for example, a present power supply/demand state and a predicted power supply/demand state for each time zone. Subsequently, ECU 16 and control device 310 uses the scheduled exchange message pair to exchange charge related information at S51 and S62. ECU 16 uses the scheduled replacement demand to provide EVSE 300 with the scheduled departure time of the vehicle 100 and the like. The charge related information sent from EVSE 300 to the vehicle 100 includes EM information. In the following S63, the control device 310 determines whether or not to require the second standby (communication stoppage) based on, for example, EM data. On the other hand, ECU 16 determines whether or not a second standby is requested in the following S52.

Prior to starting the charge control, it is determined that S52, S63 is NO, and the process proceeds to S53, S64. In S53, ECU 16 notifies EVSE 300 of the charge control. For example, ECU 16 may use the charge loop requirement to transmit a vehicle-side charge parameter limit (e.g., an upper limit of each of the charge voltage, the charge current, and the charge power) to EVSE 300. In S64, the control device 310 determines a target value (power setting value) of the charging parameter based on the limit value of the charging parameter received from ECU 16 and the aforementioned scheduled departure time (S51), and controls the charger 331 so that the charging parameter approaches the determined target value. That is, the charger 331 is controlled based on the instruction determined by the control device 310. The control device 310 may execute EM requested by EMS 500 (for example, improve the supply-demand balance) by the charge control. The control device 310 may determine a target charge parameter based on EM. The control device 310 also uses the charge loop response to notify ECU 16 of the present EVSE status, the determined power setpoint, and the like. Thereafter, the process shown in FIG. 5 ends, and the process proceeds to S18, S26 of FIG. 3. However, while the power transfer is continued without changing the control mode, the process of S17, S25 of FIG. 3 (the process flow shown in FIG. 5) is repeatedly executed. In S64, the target of the charge parameter is repeatedly set. The current target may be temporarily set to 0 A. As described above, in the dynamic control mode, no negotiation takes place and the control is entirely left to EVSE 300 (offboard system). In the dynamic control mode, power transfer is performed under the initiative of SECC (control device 310).

After the charge control of the battery 11 is started by S53, S64 process, if the control device 310 wants to stop the communication with the vehicle 100 (YES in S63), the control device 310 requests the vehicle 100 to perform the second standby (communication stop) in S65. Thereafter, the control device 310 suspends communication with the vehicle 100 in S66. When the vehicle 100 receives the second standby request from EVSE 300 (YES in S52), the process proceeds to S54, S67. In S54, ECU 16 determines whether the communication is resumed. In S67, the control device 310 determines whether to resume the charge control. While the control device 310 does not wish to resume the charge control (NO at S54, S67), S54, S67 is repeated and the charge is stopped and the communication is stopped. Thereafter, when the control device 310 reaches a timing at which it is desired to resume the charge control (YES in S67), the control device 310 resumes the communication in S68. As a result, it is determined that S54 is YES, the process proceeds to S53, S64, and the charge control is also resumed.

As described above, the power transfer method according to this embodiment includes the respective processes illustrated in FIGS. 2 to 5. The vehicle 100 performs power transfer with EVSE 300 (electrical equipment). Vehicle 100 performs power transfer in either the first control mode or the second control mode (S16, S17). The vehicle 100 acquires user mode information indicating which of the first control mode and the second control mode the user of the vehicle 100 desires (see FIG. 2). The vehicle 100 uses the user mode information to S13 which of the first control mode and the second control mode is to be notified to EVSE 300. In such a configuration, the vehicle 100 (ECU 16) determines which of the first control mode and the second control mode is to be notified to EVSE 300 based on the setting (first user setting/second user setting) by the user of the vehicle 100. This facilitates the power transfer desired by the vehicle user.

In the scheduled control mode, communication between the vehicle 100 and EVSE 300 may also be stopped while the power transfer is temporarily stopped in response to a request from the vehicle 100 (FIG. 4). Therefore, power consumption can be suppressed by stopping communication. On the other hand, in the dynamic control mode, the communication between the vehicle 100 and EVSE 300 is maintained even when the power transfer is temporarily stopped unless EVSE 300 requests the vehicle 100 to stop the communication (FIG. 5). In this way, power transfer control (charge control) that is entrusted to EVSE 300 in the dynamic control mode is smoothly performed.

In the above embodiment, the first power transfer in which the electrical equipment transmits the electric power for charging the electric storage device to the vehicle has been exemplified. However, the type of the power transfer is not limited to the first power transfer (charging), and the control illustrated in FIGS. 3 to 5 may be applied to the second power transfer in which the vehicle sends the electric power discharged from the power storage device to the electrical equipment, or the third power transfer in which the electric power is bidirectionally exchanged between the vehicle and the electrical equipment. Note that each of the first and second power transfers may be capacitive power transfer (CPT) or wireless power transfer (WPT). The third power transfer is also referred to as “BPT (Bidirectional Power Transfer”).

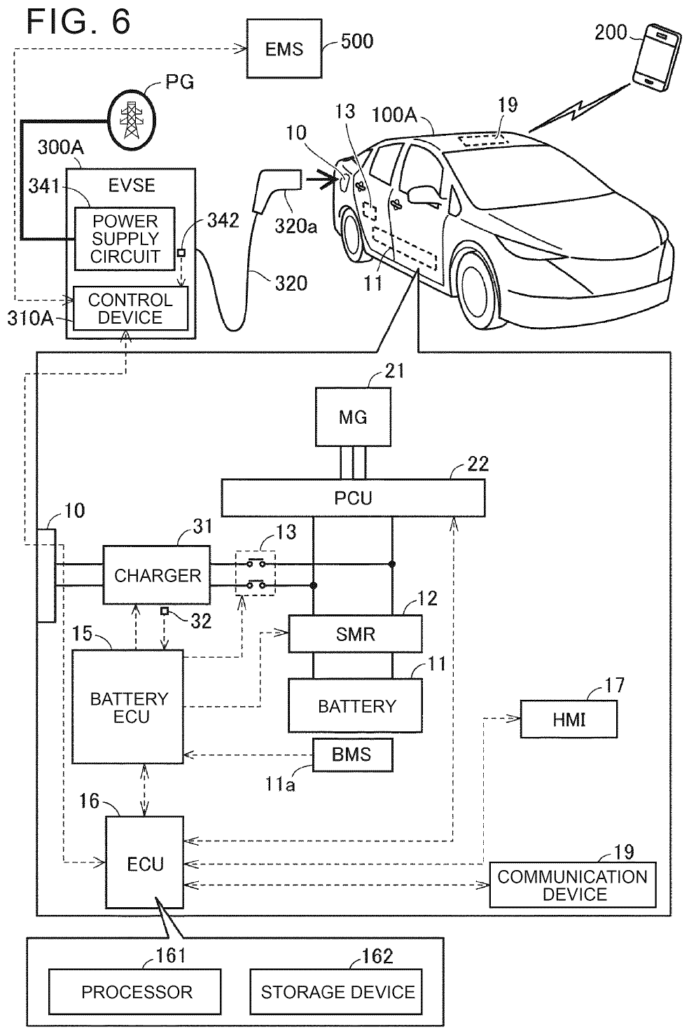

EVSE 300 shown in FIG. 1 is configured to provide DC power to vehicle 100. However, the configuration of the vehicle and EVSE is not limited to the configuration illustrated in FIG. 1. FIG. 6 is a diagram illustrating a modification of the configuration illustrated in FIG. 1. In the power transfer system shown in FIG. 6, the charger is mounted on the vehicle instead of EVSE.

Referring to FIG. 6, a vehicle 100A includes a charger 31 and a detector 32. The charger 31 includes a power conversion circuit (for example, an inverter). The power conversion circuitry performs DC (DC)/AC (AC) conversion. The detector 32 includes various sensors that detect charge parameters (current, voltage, and the like), and outputs the detection result to ECU 15. ECU 15 controls the charger 31 in accordance with an instruction from ECU 16. EVSE 300A also includes a control device 310A, power supply circuitry 341, and a detector 342. The power supply circuitry 341 converts the electric power received from the power system PG into electric power suitable for power supply to vehicle, and outputs the converted electric power to the charging cable 320. The detector 342 includes various sensors for detecting power supply parameters (current, voltage, and the like), and outputs the detection result to the control device 310A. EVSE 300A provides AC power to the vehicle 100A. The control device 310A is configured to communicate with each of ECU 16 and EMS 500. In such a power transfer system, ECU 16 controls the charger 31 to control the charge of the battery 11. In the scheduled control mode, ECU 16 controls the charger 31 according to the agreed power transfer profile. In the dynamic control mode, ECU 16 controls the charger 31 in accordance with an instruction from the control device 310A.

Each of the vehicles 100, 100A illustrated in FIGS. 1 and 6 is merely an exemplary vehicle that performs power transfer. Other vehicle configurations may also be employed. For example, vehicle may have configurations that can support both AC and DC charging. In addition, the vehicle may be configured to be capable of contactless charging. The configurations illustrated in FIGS. 1 and 6 may be changed so that external power supply (power supply from the battery 11 to the outside of the vehicle) can be performed. For example, the chargers 331 and 31 may be changed to bidirectional chargers and dischargers. Further, each of EVSEs 300, 300A illustrated in FIGS. 1 and 6 is merely an example of the electrical equipment. Any electrical equipment (accessories, devices, power outlets, appliances, etc.) can be employed that provides electrical power to EV and communicates with EV as needed.

The embodiment disclosed herein should be considered as illustrative and not restrictive in all respects. The scope of the present disclosure is shown by the claims rather than the above embodiment, and is intended to include all modifications within the meaning and the scope equivalent to those of the claims.

What is claimed is:

1. A vehicle that performs power transfer to and from electrical equipment, wherein:
the vehicle is configured to perform the power transfer in either a first control mode or a second control mode;
the first control mode is a control mode in which the power transfer is performed based on an instruction determined by the vehicle;
the second control mode is a control mode in which the power transfer is performed based on an instruction determined by the electrical equipment;
the vehicle is configured to acquire user mode information indicating whether a user of the vehicle desires the first control mode or the second control mode; and
the vehicle uses the user mode information to determine which of the first control mode and the second control mode is to be notified to the electrical equipment.

2. The vehicle according to claim 1, wherein:
the vehicle is configured to further acquire equipment mode information indicating whether the electrical equipment supports the first control mode; and
the vehicle notifies the electrical equipment of the first control mode when the user mode information indicates that the user desires the first control mode and the equipment mode information indicates that the electrical equipment supports the first control mode.

3. The vehicle according to claim 2, wherein when the vehicle acquires, during the power transfer in the first control mode, the user mode information changed to indicate that the user desires the second control mode, the vehicle notifies the electrical equipment of the second control mode.

4. A system including the vehicle according to claim 1 and the electrical equipment, wherein:
after the vehicle notifies the electrical equipment of either the first control mode or the second control mode, the vehicle and the electrical equipment perform the power transfer in either the first control mode or the second control mode, whichever was notified;
in the first control mode, there is a case where communication between the vehicle and the electrical equipment is stopped during a period in which the power transfer is temporarily stopped, in response to a request from the vehicle; and
in the second control mode, the communication between the vehicle and the electrical equipment is maintained even during the period in which the power transfer is temporarily stopped, unless the electrical equipment requests the vehicle to stop the communication.

5. The system according to claim 4, wherein:
the system further includes user equipment that is operated by the user;
the user equipment is configured to receive an input indicating whether the user desires the first control mode or the second control mode; and
the user equipment is configured to send to the vehicle the user mode information according to the input from the user.
